(19) United States
(12) Patent Application Publication
(10) Pub. No.: US 2015/0027446 A1
(43) Pub. Date: Jan. 29, 2015

(54) Respiratory protection mask

(71) Applicant: Tristan Brega, Toorak (AU)

(72) Inventor: Tristan Brega, Toorak (AU)

(21) Appl. No.: 14/337,433

(22) Filed: Jul. 22, 2014

(30) Foreign Application Priority Data
Jul. 26, 2013 (AU) 2013209363

(51) Int. Cl. A63B 29/02; A62B 18/10; A62B 23/02; A62B 18/02

(52) U.S. Cl. CPC A63B 29/02; A62B 18/02; A62B 18/10; A62B 23/025
USPC 128/206.16; 128/206.28; 128/207.12; 128/207.11

(57) ABSTRACT

A respiratory protection mask (10) for alpine recreationalists, including a frame structure (14) that creates an air void (12) about a users mouth and nose and an outer covering (32) that creates a seal about the air void (12), the users mouth and nose. The mask (10) includes an inlet (20) for allowing air to be drawn into the air void (12) from external of the mask (10), and an outlet (26) for allowing exhaled air to be exhausted from the mask (10) at a location spaced from the inlet (20).

### CROSS-REFERENCE TO RELATED APPLICATION

This application claims the benefit of priority to Australian Patent Application Number 2013209363 filed Jul. 26, 2013, having the same title and the same inventor, and which is incorporated by reference herein in its entirety.

### FIELD OF THE INVENTION

The present invention relates to a respiratory protection mask for use by alpine recreationalists.

### BACKGROUND OF THE INVENTION

Avalanches are caused by a rapid change in weight. This weight may be a large amount of snow, the sudden impact of a skier or the presence of a snowmobile. Many factors, including temperature, wind, snowfall, terrain and the steepness of the slope, can affect the likelihood of an avalanche. Avalanches usually occur in backcountry or off-piste areas on ungroomed/uncontrolled slopes outside main ski areas. These areas are accessed by skiers and snowboarders either manually with the assistance of climbing skins or snowshoes, or with snowcats or helicopters.

When an avalanche victim is completely buried by avalanche debris there is a non-linear relationship between the time it takes to excavate a victim and their probability of survival. It has been reported that the probability of survival for avalanche victims recovered within the first 18 minutes is 91%; this drops significantly to 34% when burial times range from 19 to 35 minutes. Victims recovered in this time period are usually located by their companions. The average burial time for victims successfully recovered by professional search and rescue teams is 70 minutes, with their operational goal being 90 minutes. The survival rate for victims recovered by professional search and rescue teams is 14.3%. The rapid drop in survival rate is caused by acute asphyxiation and affects avalanche victims that are completely buried with no access to an air pocket. Asphyxiation accounts for up to 80% of all avalanche deaths, with the principal cause being the accumulation of exhaled carbon dioxide. Higher density snow may result in more rapid asphyxia during avalanche burial because the diffusion of carbon dioxide in snow is inversely related to snow density.

Avalanche debris comprises up to 40% to 60% breathable air and it is possible for avalanche victims to breathe this air and survive for up to 90 minutes if exhaled carbon dioxide is removed from the respiratory environment. A number of attempts have been made to reduce asphyxiation in avalanches. AvaLung devices by Black Diamond are products that enable avalanche victims to breathe air contained within a snowpack via a semi-permeable mesh, whilst diverting exhaled carbon dioxide away from the respiratory environment. However, this system requires the user to notice the potential or presence of an avalanche and place a mouthpiece in their mouth and begin to breathe through it. This system is difficult to use, uncomfortable to wear, inconvenient and do not protect the user's airways. It is very difficult to hold the device in the mouth for a prolonged period of time, and it is difficult to place the mouthpiece in the mouth without using your hands. If the user is wearing a balaclava or bandana to protect their mouth and nose, this would first need to be removed. In some situations, where a victim has already been partially buried, they may not have access to their hands or the mouthpiece. Another issue with this system is that a significant amount of moisture builds up within the device, which can become frozen, blocking the airway. Additionally, the user's nose and lips are fully exposed, increasing the chance of the user's airways becoming blocked by inhaling snow, ice or water and reducing the user's ability to retain heat.

It is therefore a desired object of the present invention to provide a more user-friendly respirator system that can be used by alpine recreationalist, which is advantageously comfortable during both normal and high levels of physical exertion, minimises moisture and condensation build up and accounts for variations in body shape.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

According to a first aspect, the present invention provides a respiratory protection mask, including:

a frame structure that creates an air void about a user's mouth and nose;

an outer covering that creates a seal about the air void, the user's mouth and nose;

an inlet for allowing air to be drawn into the air void from external of the mask; and

an outlet for allowing exhaled air to be exhausted from the mask at a location spaced from the inlet.

The frame structure creates a supportive skeletal structure that creates and maintains the air void about the user's mouth and nose. The frame structure is preferable constructed using a material that has a degree of flexibility, but is capable of maintaining the air void under pressure. Such material may be Nylon™, semi-rigid silicone or TPE for example.

The frame structure advantageously integrates or connects with conduits for channelling exhaled air from the air void to the outlet, expelling the carbon dioxide to an area outside of the respiratory environment. The outlet is preferably located at the rear of the respiratory protection mask, such that it may be positioned at the back of the user's neck or head. Conduits are advantageously pipes having an inlet from the air void and may curve around the side of a user's head/neck area to the back of the user's neck or head. The conduits may include one-way valves, such that exhaled air is pushed through the one-way valve into the conduit and cannot re-enter the air void. The respiratory protection mask preferably includes two conduits, which may extend from opposing sides of the air void and meet at the outlet. The outlet is advantageously covered with a semi-permeable mesh, such that exhaled air can be expelled, but snow, ice and water is prevented from entering the conduits.

The frame structure creating the air void may be covered by a semi-permeable membrane, such that water vapour is allowed to escape from the air void, but air, snow, ice and water is prevented from entering the air void from the external environment through the frame structure about the inlets. Suitable semi-permeable membrane can take many forms, but may advantageously be an expanded polytetrafluroethylene (ePTFE) fabric, such as stretch Gore-Tex™. This semi-permeable membrane also seals the air void, ensuring exhaled air is directed towards the outlet.

There are preferably two inlets for air to be drawn from the external environment. Each inlet is preferably spaced apart at the front of the air void and may include one-way valves to prevent exhaled air from being expelled into the respiratory environment. The one-valves are preferably covered by semi-permeable mesh such that air is allowed into the air void, with the mesh blocking entry of snow, ice and water.

The outer covering is advantageously a flexible sleeve that wraps around the user's neck and lower portion of the face and head. The outer covering secures the respiratory protection mask to the user and creates a seal about the air void, such that air can only enter through the inlet(s) and air can only be exhaled through the outlet(s). This creates a passive system, such that it is able to be worn by the user during normal activity and does not require active engagement in the event of an avalanche situation. The outer covering may also extend over the top of the user's head, creating a balaclava with integrated respiratory protection.

The outer covering may fully or partially sit on the inner side of the conduits. The outer covering is preferably made from a stretchable fabric, such as Nylon™. It may additionally utilise straps to increase the seal, such straps may be elastic and can be tightened around a user's head and neck. Two tension points may be provided to ensure a seal, one around the top of the outer covering and one around either the bottom or the middle of the user's neck.

The outer covering may advantageously be lined with a material, such as fleece, to increase the comfort of the user, providing a soft surface against the user's skin.

The shape of the respiratory protection mask is advantageously such that it can be comfortably worn with an alpine recreationalist's other equipment, such as goggles, a helmet, hydration backpacks and spine padding.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

The invention will now be described, by way of example only, with reference to the accompanying drawings, in which:

FIG. 1 is a front view of a person wearing a respiratory protection mask according to a first embodiment of the invention;

FIG. 2 is a rear view of the respiratory protection mask of FIG. 1;

FIG. 3 is a front perspective view of a frame structure according to another embodiment of the present invention;

FIG. 4 is a front perspective view of the frame structure of FIG. 3, with a semi-permeable membrane affixed to the outside of the air void;

FIG. 5 is a front view of a respiratory protection mask according to a second embodiment;

FIG. 6 is a side perspective view of the respiratory protection mask of FIG. 5;

FIG. 7 is a rear perspective view of the respiratory protection mask of FIG. 5;

FIG. 8 is a front view of the respiratory protection mask of FIG. 5 showing the air inlets with the semi-permeable mesh removed;

FIG. 9 is a partial rear side view of the respiratory protection mask of FIG. 5 with the one-way valve in the exhaust port removed; and

FIG. 10 is a top view of an alpine recreationalist wearing the respiratory protection mask of FIG. 1 buried in avalanche snow.

### DETAILED DESCRIPTION OF THE EMBODIMENTS

A respiratory protection mask 10 is shown in the drawings as worn by an alpine recreationalist in environments that may be prone to avalanche conditions. The mask 10 is a passive system that allows a user to wear it during normal and extreme physical exertion, such as skiing, and it acts as a protective mask from wind, rain, cold and UV. The mask 10 allows a user to comfortably breathe through the mask in normal conditions.

As shown in FIG. 10, if a user is buried during an avalanche, the system requires no interaction from the user to enable it to work to prolong the potential asphyxiation of the victim. The mask 10 allows a user to survive completely buried under snow for at least 90 minutes, greatly increasing the chance of successful rescue by search and rescue workers.

The key element of the invention is the creation of an air void 12 about a user's mouth and nose. This air void 12 is maintained during burial under snow preventing the user's airways from becoming blocked by snow or ice. The prevention of asphyxiation comes from the mask's ability to direct exhaled air containing carbon dioxide to a location spaced from the respiratory environment where fresh oxygen is drawn into the air void 12.

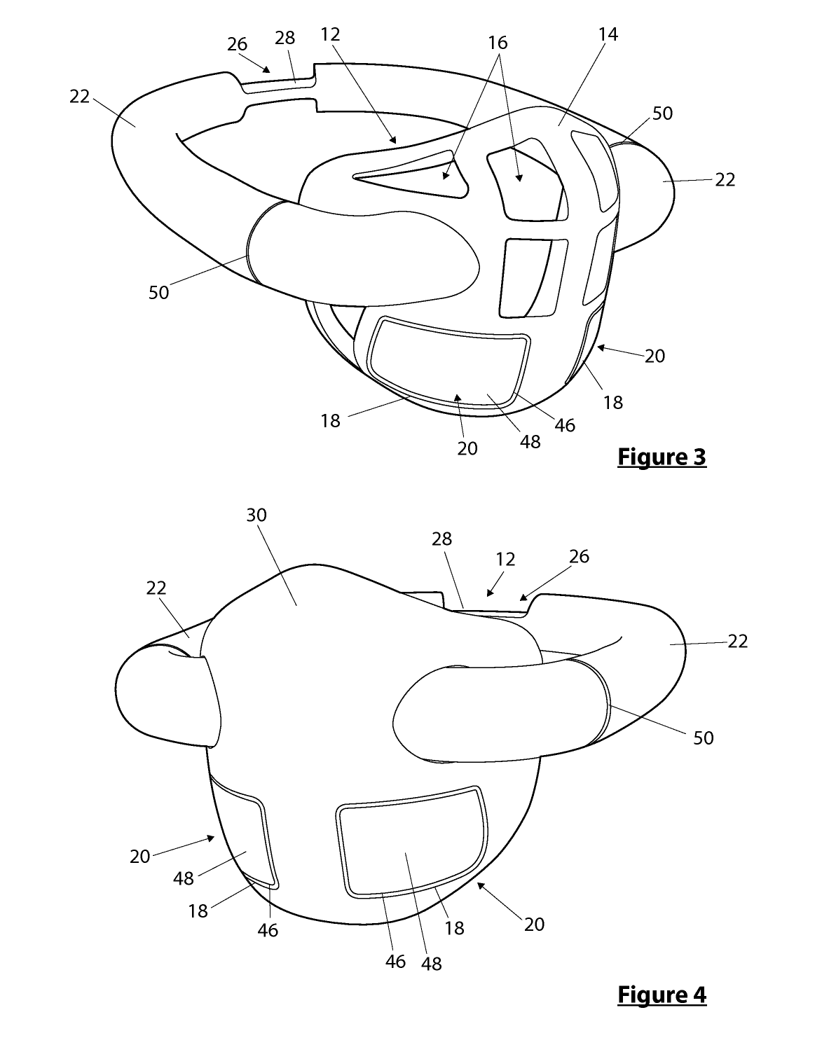

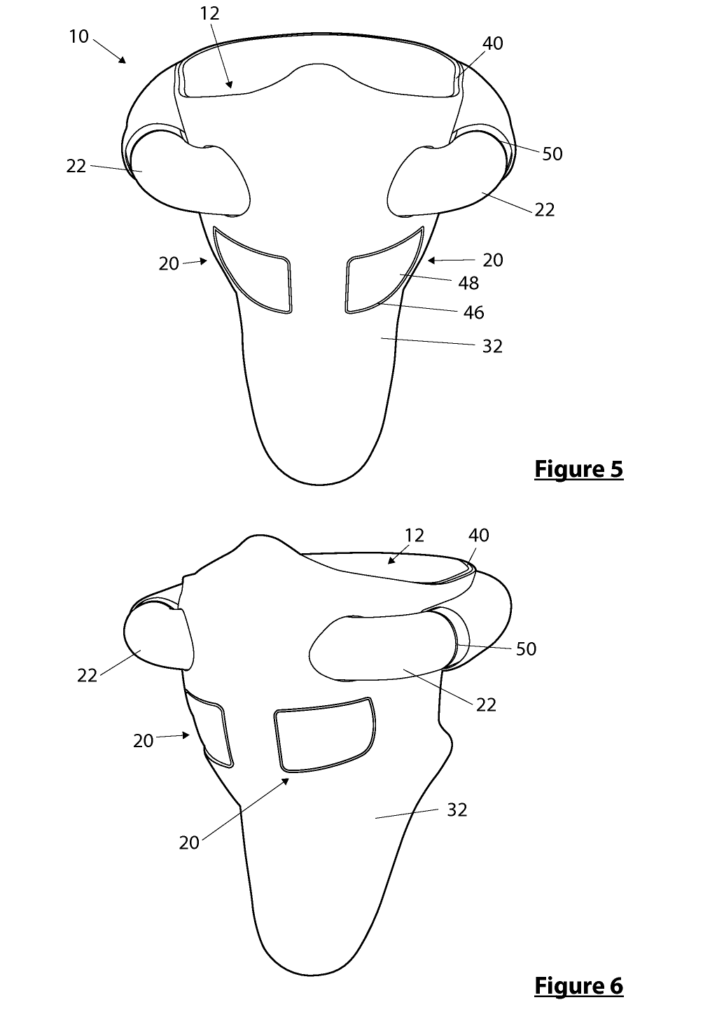

The air void 12 is created from an underlying frame structure 14 that sits about the user's mouth and nose, and can extend under a user's chin. The frame 14 is best shown in FIG. 3, which takes the form of a semi-rigid structure that has a degree of flexibility to allow it to be slid over the user's head and adapt to varying facial features. Cut-out sections 16 are provided to increase flexibility and reduce weight. In the embodiment shown, cut-out sections 18 are provided to create two inlets 20 into the air void 12; the inlets 20 will be described in further detail below.

Integrated into the frame 14 in the embodiment illustrated are conduits 22, which are pipes that have an inlet opening (not shown) from the air void 12. The pipes 22 extend from the air void 12, curving around the side of a user's head to the back of the neck, where the outlet 26 is provided. A frame portion 28 is provided between the two pipes 22 to maintain the outlet 26 and keep the shape of the mask.

About the portion of the frame structure 14 creating the air void 12 a thin layer is adhered, being a semi-permeable membrane 30. The purpose of the membrane 30 is to reduce the moisture build up in the air void 12 whilst maintaining the seal around a user's face. Many respirators create a build-up of moisture about a user's mouth and nose, which, when used by alpine recreationalists in cold environments, can result in moisture freezing, ruining equipment. The membrane 30 contains pores larger than water vapour to allow it to escape from the air void 12, with the pores being smaller than liquid water or air. Suitable material for the membrane is expanded polytetrafluroethylene (ePTFE) fabric, such as stretch Gore-Tex™. As shown in FIG. 4, the membrane is applied over the air void frame, with cut-out sections 18 being left exposed to enable air to enter the inlets 20.

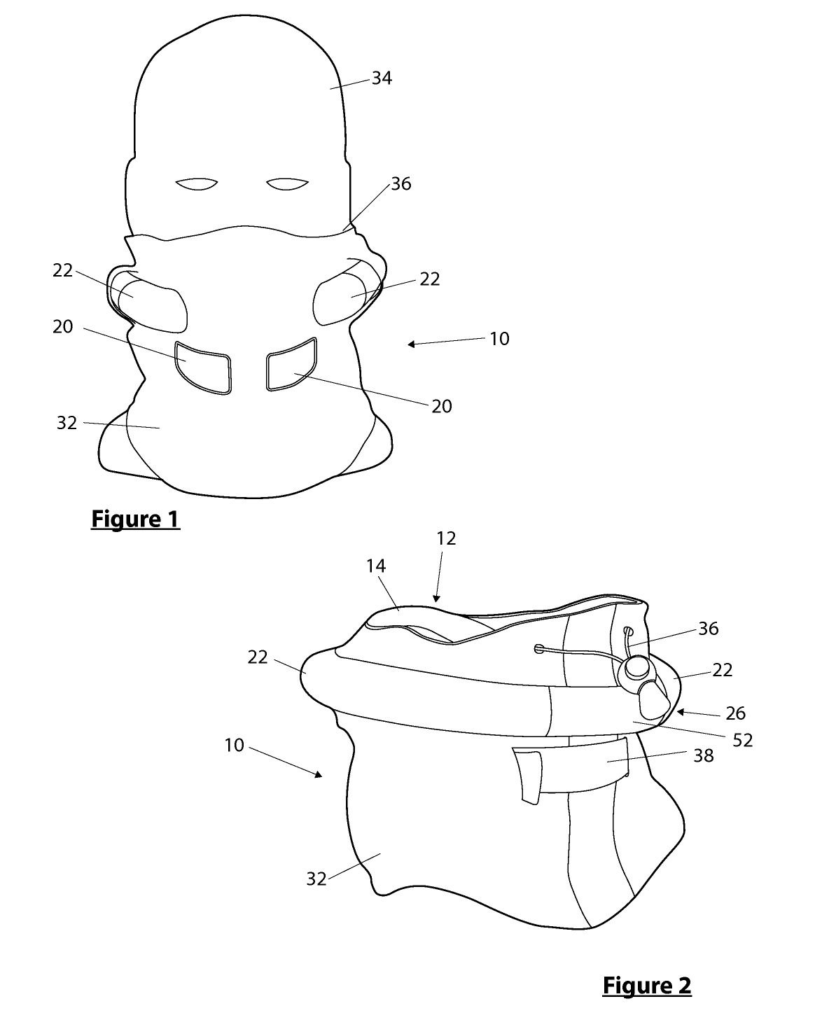

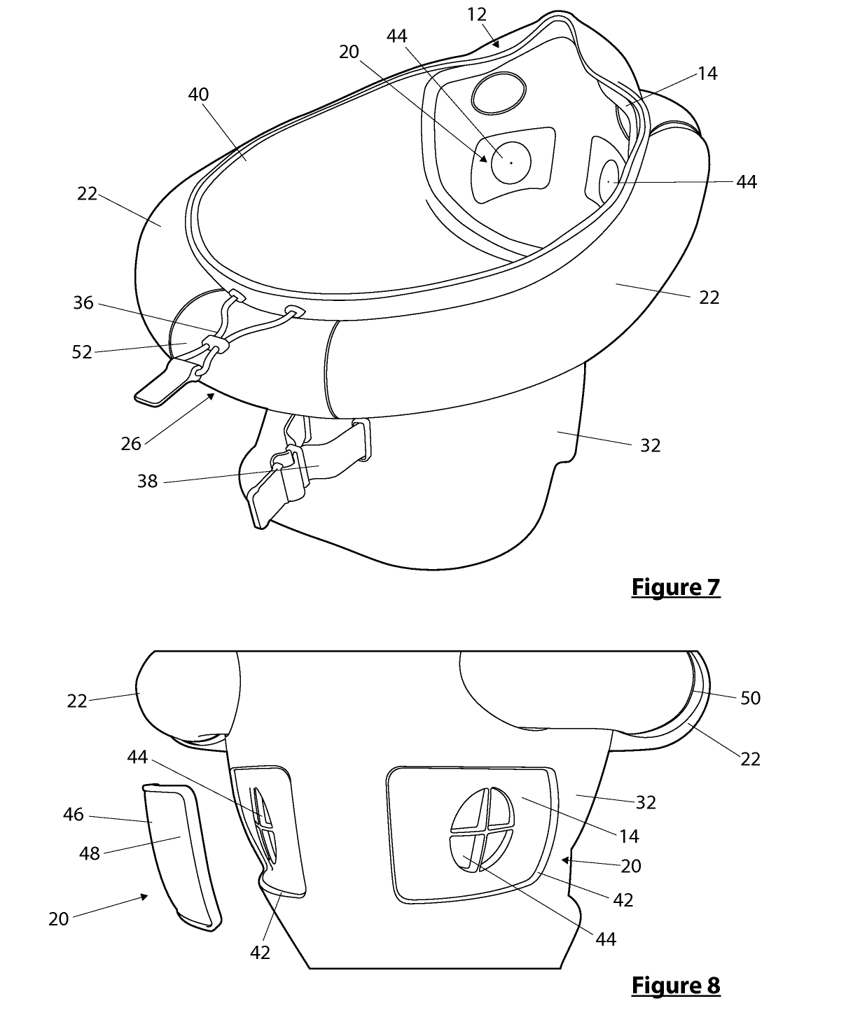

An outer covering 32 is then provided over the frame structure 14 extending as a sleeve about the user's lower face and neck, see FIG. 1. The outer covering 32 is flexible such that it can be pulled down over the top of a user's head 34, whilst creating a seal against the user's face and neck such that air cannot escape the air void 12. As shown in the embodiment in FIGS. 1 and 2, this may be achieved by a fairly flexible material and the use of elastic straps 36, 38, one 36 about the top of the mask and another 38 around the middle of the user's neck, such that it creates tension points about the smaller diameter sections of a user's face and neck. In the embodiment shown in FIG. 7, a most rigidly formed outer covering 32 may be provided, with an upper strap 36 and a lower strap 38 also provided. As can be seen in FIG. 7, the top lip of the mask 10 pulls over the top of the air void frame 14, sealing against a user's nose and cheeks. The material used to make the outer covering 32 is a stretchable fabric, such as Nylon™, which may be lined with a layer of fleece fabric 40 to increase the comfort against the user's skin. The outer covering 32 typically sits inside the inner surface of the pipes 22 to increase the ability to seal against a user's face. It will be appreciated that alternative arrangements may be utilised, for example, the outer covering 32 may take the form of a balaclava, extending over the user's head.

The inlets 20 are shown best in FIGS. 6 and 8 and are apertures 42 created through the frame 14 and the outer covering 32 to open the air void 12 to the respiratory environment external of the mask 10. The inlets 20 include one-way valves 44 that allow air to be drawn into the air void 12 by the user inhaling, but prevent exhaled air from being expelled directly into the respiratory environment directly in front of the mask where the user is inhaling their next breath. A cover 46 is inserted into the apertures 42, which contains a layer of semi-permeable mesh 48. The mesh 48 allows the passage of air into the air void 12, but prevents the passage of snow and ice and therefore prevents the blockage of the inlet.

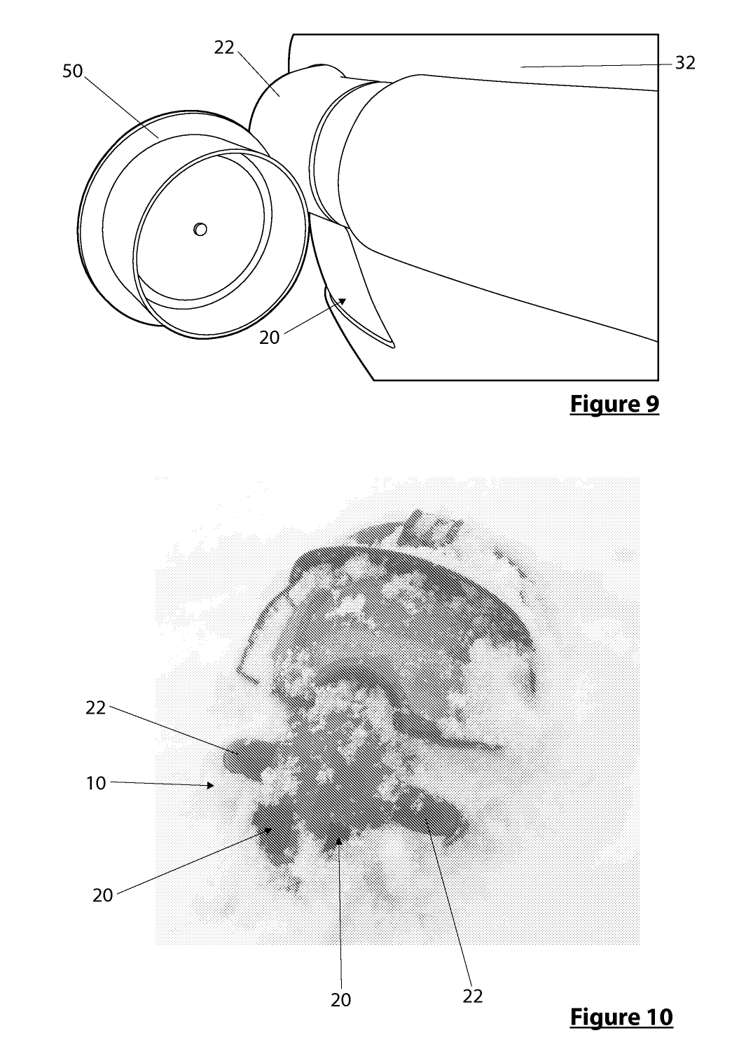

The pipes 22 also include one-way valves 50, as best shown in a removed condition in FIG. 9 and in an assembled position in FIG. 3. These one-way valves 50 prevent exhaled carbon dioxide from re-entering the air void 12 once it has been pushed into the rear section of the pipes 22. The outlet 26 is located at the end of the pipes 22, where they converge, with the outlet 26 being covered by a layer of semi-permeable mesh 52, as best shown in FIG. 7.

In normal use, during alpine recreation, as user can slide the mask 10 over their head, as shown in FIG. 1, and it functions as a protective barrier, much like a balaclava or bandana, to protect the user's face and airways from cold air, snow, water, UV etc. A user can easily breathe through the mask in normal conditions and during periods of high physical activity.

If the user finds themselves in the situation where an avalanche is threatening or finds themselves in the midst of an avalanche, the user does not need to activate any devices or insert a mouthpiece to engage the respiratory protection mask. As the system is passive, the mask works in all circumstances once a user is wearing the mask.

As shown in FIG. 10, if a wearer is buried or partially buried by snow, they can continue to breathe normally. Air is drawn into the air void 12 via the inlets 20, which are protected by semi-permeable mesh 48 preventing snow from entering the air void 12. Even if completely buried under snow, oxygen can be drawn out of the snow by the user into the air void 12. When a user exhales, the exhaled air, with carbon dioxide, is prevented from passing back through the inlets 20 by the one-way valves 44. The exhaled air therefore passes into the pipes 22, being forced through the one-way valves 50 into the rear of the pipes 22 and out through the outlet 26. The outlet is prevented from filling with snow by the inclusion of semi-permeable mesh 52. As the outlet 26 is located at a spaced distance from the inlets 20 and therefore the respiratory environment surrounding the inlets, carbon dioxide levels in the direct respiratory environment are reduced preventing asphyxiation.

The respiratory protection mask allows the user to breathe air that is contained within the snow during avalanche burial without the risk of inhaling snow, ice or water, but also allows the user to breathe normally during both normal and high levels of physical exertion.

The respiratory protection mask completely covers the user's nose and mouth, such that when a user is caught in an avalanche, it will be impossible for avalanche debris to block the user's airway because there is a physical barrier between the user and the avalanche debris. The frame structure is such that the air void is constantly maintained even whilst buried in snow, increasing the ability to breathe.

It will be understood that the invention disclosed and defined in this specification extends to all alternative combinations of two or more of the individual features mentioned or evident from the text or drawings. All of these different combinations constitute various alternative aspects of the invention.

What is claimed is:

1. A respiratory protection mask, comprising:
a frame structure that creates an air void about a user's mouth and nose;
an outer covering that creates a seal about the air void and about the user's mouth and nose;
an inlet which allows air to be drawn into the air void from the environment external to the mask; and
an outlet which allows exhaled air to be exhausted from the mask at a location spaced from the inlet.

2. A respiratory protection mask according to claim 1, wherein the frame structure maintains the air void under pressure.

3. A respiratory protection mask according to claim 1, wherein the frame structure is constructed from a flexible material.

4. A respiratory protection mask according to claim 1, wherein the frame structure integrates or connects with at least one conduit for channelling exhaled air from the air void to the outlet.

5. A respiratory protection mask according to claim 4, wherein the outlet is located at the rear of the respiratory protection mask.

6. A respiratory protection mask according to claim 5, wherein each of the at least one conduits are pipes having an inlet from the air void and which curve around the side of a user's head/neck area to the outlet.

7. A respiratory protection mask according to claim 4, wherein each of the at least one conduits includes a one-way valve which allows exhaled air to be pushed through the one-way valve into the conduit, and which prevents exhaled air from re-entering the air void.

8. A respiratory protection mask according to claim 4, wherein said at least one conduit includes two conduits which extend from opposing sides of the air void and meet at the outlet.

9. A respiratory protection mask according to claim 1, wherein the outlet is covered with a semi-permeable mesh which allows the passing of exhaled air and which prevents the passing of snow, ice and water.

10. A respiratory protection mask according to claim 1, wherein the frame structure is covered by a semi-permeable membrane which allows water vapour to escape from the air void, and which prevents air, snow, ice and water from the environment external to the mask from entering the air void through the frame structure about the inlets.

11. A respiratory protection mask according to claim 10, wherein the semi-permeable membrane comprises expanded polytetrafluroethylene (ePTFE) fabric.

12. A respiratory protection mask according to claim 1, including two inlets for air to be drawn from the environment external to the mask.

13. A respiratory protection mask according to claim 12, wherein the inlets are spaced apart at the front of the air void.

14. A respiratory protection mask according to claim 1, wherein the inlet includes a one-way valve which prevents exhaled air from being expelled into the respiratory environment.

15. A respiratory protection mask according to claim 14, wherein the one-valves are covered by semi-permeable mesh, wherein the mesh allows air into the air void, and wherein the mesh blocks the entry of snow, ice and water into the air void.

16. A respiratory protection mask according to claim 1, wherein the outer covering is a flexible sleeve that wraps around at least the user's neck and lower portion of the face and head, thereby securing the respiratory protection mask to the user and creating a seal about the air void.

17. A respiratory protection mask according to claim 1, wherein the respiratory protection is passive, such that it is able to be worn by the user during normal activity and does not require engagement by the user.

18. A respiratory protection mask according to claim 1, wherein the outer covering comprises a stretchable fabric.

19. A respiratory protection mask according to claim 12, wherein at least one of the inlets includes a one-way valve to prevent exhaled air from being expelled into the respiratory environment.
